(19) United States
(12) Patent Application Publication
(10) Pub. No.: US 2026/0094840 A1
(43) Pub. Date: Apr. 2, 2026

(54) NEGATIVE ELECTRODE OF SECONDARY BATTERY, MANUFACTURING METHOD OF NEGATIVE ELECTRODE, AND SECONDARY BATTERY WITH NEGATIVE ELECTRODE

(71) Applicant: Prime Planet Energy & Solutions, Inc., Tokyo (JP)

(72) Inventor: Surim KANG, Kobe-shi (JP)

(21) Appl. No.: 19/329,569

(22) Filed: Sep. 16, 2025

(30) Foreign Application Priority Data
Sep. 27, 2024 (JP) 2024-169493

(51) Int. Cl. H01M 4/62; H01M 4/02; H01M 4/04; H01M 4/36; H01M 4/587; H01M 10/0525

(52) U.S. Cl. CPC H01M 4/628; H01M 4/0404; H01M 4/366; H01M 4/587; H01M 10/0525; H01M 2004/027

(57) ABSTRACT

Provided is a technique for suppressing a swell of the negative electrode. In the negative electrode disclosed herein, a negative electrode active material layer includes a first layer at a negative electrode current collector side and a second layer at a surface layer side. The first layer contains a first Si-containing particle. The second layer contains a second Si-containing particle. When an expansion rate S1 of the first Si-containing particle is treated as 1, an expansion rate S2 of the second Si-containing particle is more than 0.3 and not more than 0.9. The first Si-containing particle and the second Si-containing particle include LiF coating layers. A peak intensity ratio of a LiF of the first Si-containing particle is larger than a peak intensity ratio of the LiF of the second Si-containing particle. A difference between the ratios is at least 0.050.

### CROSS REFERENCE TO RELATED APPLICATIONS

The present application claims the priority based on Japanese Patent Application No. 2024-169493 filed on Sep. 27, 2024, the entire contents of which are incorporated in the present specification by reference.

### BACKGROUND OF THE DISCLOSURE

### 1. Technical Field

A present disclosure relates to a negative electrode of a secondary battery, and a manufacturing method of the negative electrode. The present disclosure also relates to the secondary battery in which this negative electrode is used.

### 2. Background

Recently, a secondary battery is suitably used for a portable power supply of a personal computer, a portable terminal, or the like, for a power supply of driving automobiles, such as battery electric vehicle (BEV), hybrid electric vehicle (HEV), and plug-in hybrid electric vehicle (PHEV), or the like.

Regarding a purpose of the power supply for driving automobiles, especially regarding a purpose of the power supply for driving the BEV, from a perspective of extending a driving distance of the vehicle, it is desired to make the secondary battery have a higher capacity. As a negative electrode active material whose capacity is high, a Si-containing particle is known, and it is known, with the Si-containing particle, to be able to make the secondary battery have the higher capacity. Japanese Patent Application Publication No. 2010-33830 discloses a negative electrode that consists of a negative electrode, a positive electrode, and a nonaqueous electrolyte having a lithium ion electrically conductive property and that is used for a nonaqueous electrolyte secondary battery. The negative electrode includes a current collector and a negative electrode active material. The negative electrode active material includes an active material composite particle that contains at least 2 kinds of elemental silicons, silicon chemical compounds, and carbons whose particle size distributions are different from each other. A specific surface area size of the active material composite particle is equal to or more than 5 m²/g and not more than 50 m²/g. This document describes that, according to the configuration described above, it is possible to enhance an electrical charge and discharge cycle characteristic, suppress a drastic capacity reduction at the electrical charge and discharge cycle time, and implement improving a high-rate characteristic.

A composite particle disclosed in Japanese Unexamined Patent Application Publication No. 2019-522886 contains a carbon material, a silicon, and a lithium fluoride (LiF), and is configured with a carbon phase consisting of the carbon material and a Si—LiF mix particle. The Si—LiF mix particle is dispersed into the carbon phase at a uniform or ununiform distribution. This document describes that, by a negative electrode containing the composite particle described above, it is possible to improve a life property of a battery.

Japanese Unexamined Patent Application Publication No. 2015-537347 discloses a multilayer electrode that includes an electrically conductive layer, a first composite electrode layer, and a second composite electrode layer, in this order. Each composite electrode layer contains a particle-shaped material suitable for being used as an active material of a metal ion battery and contains a binder. A main component of the active material in the first composite electrode layer is a material that is different from a main component of an active material of the second composite electrode layer. This document describes that, according to the configuration described above, it is possible to improve both of a capacity maintenance rate of the battery and a cycle life.

### SUMMARY

Anyway, the Si-containing particle has a property that an expansion and contraction at an electrical charge and discharge time is large. The secondary battery in which the Si-containing particle is used has a problem that, when the electrical charge and the electrical discharge are repeated, as the negative electrode is repeatedly expanded and contracted, the negative electrode is expanded and an inside stress is increased. Thus, it is demanded to develop a negative electrode whose swell is smaller when the electrical charge and the electrical discharge are repeated.

In view of the above described circumstance, the present disclosure has an object for the negative electrode containing the Si-containing particle to suppress the swell of the negative electrode when the electrical charge and the electrical discharge are repeated.

A negative electrode of a secondary battery of the present disclosure includes a negative electrode current collector, and a negative electrode active material layer. The negative electrode active material layer is supported by the negative electrode current collector. The negative electrode active material layer includes a first layer positioned at a side of the negative electrode current collector and a second layer positioned at a surface layer side. The first layer contains a first Si-containing particle as a negative electrode active material. The second layer contains a second Si-containing particle as a negative electrode active material. When an expansion rate S1 of the first Si-containing particle after the electrical charge A with respect to one before the electrical charge A is treated as 1, an expansion rate S2 of the second Si-containing particle after the electrical charge A with respect to one before the electrical charge A is more than 0.3 and not more than 0.9. Here, the electrical charge A is an electrical charge in which, after a constant current electrical charge is performed under 25° C. environment by a current value being 0.01 C till 4.2 V, a constant voltage electrical charge is performed till the current value reaches 0.005 C. Each of the first Si-containing particle and the second Si-containing particle comprises a LiF coating layer. On an XPS spectrum of the first Si-containing particle measured by an XPS, a ratio of a peak intensity of an F of a LiF with respect to the peak intensity of the F of one being other than the LiF is defined as a first peak intensity ratio. On the XPS spectrum of the second Si-containing particle 14, the ratio of the peak intensity of the F of the LiF with respect to the peak intensity of the F of one being other than the LiF is defined as a second peak intensity ratio. The first peak intensity ratio is larger than the second peak intensity ratio. A difference between the first peak intensity ratio and the second peak intensity ratio is at least 0.050. In accordance with such a configuration, regarding the negative electrode containing the Si-containing particle, it is possible to suppress the swell of the negative electrode when the electrical charge and the electrical discharge are repeated.

From another aspect, a manufacturing method of the negative electrode of the secondary battery of the present disclosure includes: preparing a first paste that comprises a first Si-containing particle as a negative electrode active material and comprises a dispersion medium; preparing a second paste that comprises a second Si-containing particle as the negative electrode active material and comprises the dispersion medium; applying the first paste to coat a negative electrode current collector and to dry so as to form a dry layer of the first paste; applying the second paste to coat the dry layer of the first paste and to dry so as to form a dry layer of the second paste; and pressing the dry layer of the first paste and the dry layer of the second paste. When an expansion rate S1 of the first Si-containing particle after the electrical charge A with respect to one before the electrical charge A is treated as 1, an expansion rate S2 of the second Si-containing particle after the electrical charge A with respect to one before the electrical charge A is more than 0.3 and not more than 0.9. Here, the electrical charge A is an electrical charge in which, after a constant current electrical charge is performed under 25° C. environment by a current value being 0.01 C till 4.2 V, a constant voltage electrical charge is performed till the current value reaches 0.005 C. Each of the first Si-containing particle and the second Si-containing particle comprises a LiF coating layer. On an XPS spectrum of the first Si-containing particle measured by an XPS, a ratio of a peak intensity of an F of a LiF with respect to the peak intensity of the F of one being other than the LiF is defined as a first peak intensity ratio. On the XPS spectrum of the second Si-containing particle 14, the ratio of the peak intensity of the F of the LiF with respect to the peak intensity of the F of one being other than the LiF is defined as a second peak intensity ratio. The first peak intensity ratio is larger than the second peak intensity ratio. A difference between the first peak intensity ratio and the second peak intensity ratio is at least 0.050. In accordance with such a configuration, regarding the negative electrode containing the Si-containing particle, it is possible to suppress the swell of the negative electrode when the electrical charge and the electrical discharge are repeated. In accordance with such a configuration, it is possible to provide the negative electrode which contains the Si-containing particle and in which the swell can be suppressed when the electrical charge and the electrical discharge are repeated.

From another aspect, the secondary battery of the present disclosure includes a positive electrode, a negative electrode, and an electrolyte. The negative electrode is the above described negative electrode. By including such a configuration, regarding the negative electrode containing the Si-containing particle, it is possible to suppress the swell of the negative electrode when the electrical charge and the electrical discharge are repeated.

### BRIEF DESCRIPTION OF THE DRAWINGS

FIG. 1 is a cross section view that schematically shows a configuration of a negative electrode of a secondary battery in accordance with one embodiment of the present disclosure.

FIG. 2 is a cross section view that schematically shows a configuration of a particle of a negative electrode active material contained in a negative electrode active material layer of the negative electrode shown by FIG. 1.

FIG. 3 is a cross section view that schematically shows a configuration of a lithium ion secondary battery constructed with the negative electrode of the secondary battery in accordance with one embodiment of the present disclosure.

FIG. 4 is a schematic exploded view that shows a configuration of a wound electrode assembly of the lithium ion secondary battery shown by FIG. 3.

### DESCRIPTION OF THE EMBODIMENTS

Below, while referring to drawings, an embodiment in accordance with the present disclosure would be explained. Incidentally, a matter not described in the present description but required for performing the present disclosure can be grasped as design matters of those skilled in the art based on the related art in the present field. The present disclosure can be executed based on the contents disclosed in the present description, and the technical common sense in the present field. In the following drawings, the same numerals and signs are given to the members/parts providing the same effect. In each drawing, the dimensional relation (a length, a width, a thickness, or the like) does not reflect the actual dimensional relation. Incidentally, a numerical value range represented as “A to B” in the present description can contain A and B.

Incidentally, the term “secondary battery” in the present description represents an electricity storage device being capable of repeatedly charging and discharging. The term “lithium ion secondary battery” in the present description represents a secondary battery that uses a lithium ion as a charge carrier and implements an electrical charge and discharge by movement of the lithium ion between a positive electrode and the negative electrode.

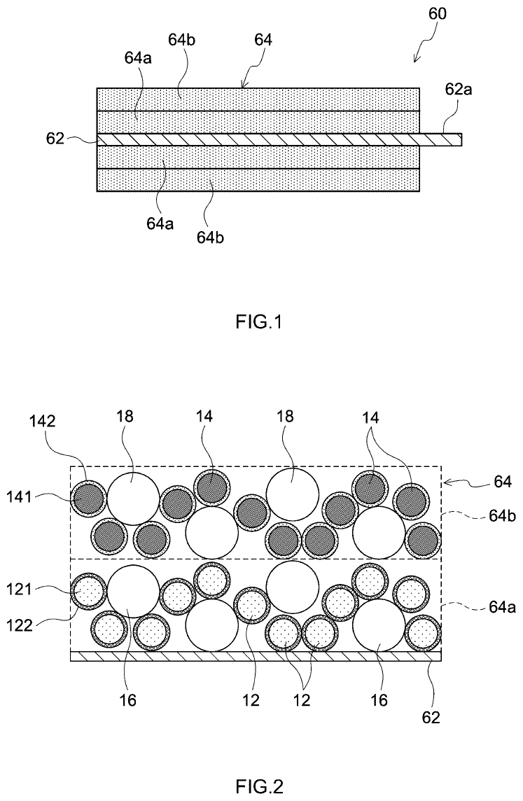

The herein disclosed negative electrode is used for a secondary battery, or suitably used for a lithium ion secondary battery. One embodiment of the herein disclosed negative electrode would be particularly explained, while referring to FIG. 1. FIG. 1 is a cross section view that schematically shows an example of a negative electrode 60 in accordance with the present embodiment, and is a cross section view that is shown along a thickness direction and a width direction. The negative electrode 60 in accordance with the present embodiment shown by FIG. 1 is the negative electrode of the lithium ion secondary battery.

As shown in the drawing, the negative electrode 60 includes a negative electrode current collector 62 and a negative electrode active material layer 64 that is supported by the negative electrode current collector 62. In other words, the negative electrode 60 includes the negative electrode current collector 62 and the negative electrode active material layer 64 that is provided on the negative electrode current collector 62. The negative electrode active material layer 64 might be provided on only one surface of the negative electrode current collector 62 or might be provided on both surfaces of the negative electrode current collector 62 as shown by the illustrated example. It is preferable that the negative electrode active material layer 64 is provided on both surfaces of the negative electrode current collector 62. As shown in the illustrated example, a negative electrode active material layer non-formation part 62a in which the negative electrode active material layer 64 is not provided might be provided at one of end parts in the width direction of the negative electrode 60. On the negative electrode active material layer non-formation part 62a, the negative electrode current collector 62 is exposed and thus the negative electrode active material layer non-formation part 62a can function as an electrical collector part. However, a configuration for electrically collecting from the negative electrode 60 is not restricted by this.

A shape of the negative electrode current collector 62 is a foil shape (or a sheet shape) in the illustrated example, but it is not restricted by this. The negative electrode current collector 62 might be formed in a rod shape, a plate shape, a mesh shape, or the like. As a material of the negative electrode current collector 62, similarly to a conventional lithium ion secondary battery, it is possible to use a metal having a good electrically conductive property (for example, copper, nickel, titanium, stainless steel, or the like), and the copper is preferable among them. As the negative electrode current collector 62, it is especially preferable to use a copper foil.

A size of the negative electrode current collector 62 is not particularly restricted, and it is good to be suitably decided in accordance with a battery design. In a situation where the copper foil is used as the negative electrode current collector 62, a thickness of it is not particularly restricted, but it might be, for example, equal to or more than 5 μm and not more than 35 μm, or preferably equal to or more than 6 μm and not more than 20 μm.

Anyway, when the electrical charge and the electrical discharge are repeated on the secondary battery, in the negative electrode active material layer that includes the negative electrode active material containing the Si, an expansion and contraction of the negative electrode active material are repeated. The repeat of the expansion and contraction described above can be a factor of causing the swell on the negative electrode active material layer. If the negative electrode active material layer swells, a thickness of the negative electrode is increased, which becomes, for example, a factor of causing a reduction in a battery performance, and thus, it is not preferable. Regarding the negative electrode active material layer, as a negative electrode current collector side and a surface layer side (a side opposite to the negative electrode current collector) are compared, a stronger swell tendency is observed at the surface layer side when the electrical charge and the electrical discharge are repeated on the secondary battery. Then, the present inventor has thought that, by making the negative electrode active material layer have a multilayer structure and by arranging a negative electrode active material layer at the surface layer side of the negative electrode active material layer whose expansion rate is relatively smaller, it is possible to suppress the swell of the negative electrode when the electrical charge and the electrical discharge are repeated on the secondary battery.

Regarding the negative electrode active material containing the Si, for example, a volume change in response to the electrical charge and the electrical discharge of the secondary battery is large. Thus, by the expansion caused at the time when the secondary battery is electrically charged, there is a possibility that a SEI coating layer being present on the surface of the negative electrode active material is damaged. When the SEI coating layer is damaged, the surface of the negative electrode active material is exposed, a nonaqueous electrolytic solution at this exposed part is decomposed, and further, the SEI coating layer is formed. When the electrical charge and the electrical discharge are repeated on the secondary battery, damaging this SEI coating layer and forming the SEI coating layer at this damaged portion (an exposed portion of the negative electrode active material) are repeatedly caused. By this, when the electrical charge and the electrical discharge are repeated, an ununiformity for a reaction, a stress, or the like, is caused on the negative electrode active material layer, which becomes a factor of causing the above described swell of the negative electrode. Thus, the present inventor has thought to provide a LiF coating layer on a surface of the negative electrode active material containing the Si.

As shown in FIG. 1, the negative electrode active material layer 64 has the multilayer structure. The negative electrode active material layer 64 herein includes a first layer 64a and a second layer 64b. As shown in FIG. 1, the first layer 64a is positioned at the negative electrode current collector 62 side. The second layer 64b is positioned at the surface layer side (here, a side opposite to the negative electrode current collector 62). Incidentally, the negative electrode active material layer 64 might include layers other than the first layer 64a and the second layer 64b, within a range where an effect of the present disclosure is not significantly inhibited. For example, the negative electrode active material layer 64 might include a middle layer between the first layer 64a and the second layer 64b, as components of these layers are mixed in the middle layer.

The negative electrode active material layer 64 contains a negative electrode active material. About this, it is explained with FIG. 2. FIG. 2 is a schematic cross section view that shows a particle of a negative electrode active material contained in the negative electrode active material layer 64 shown by FIG. 1. Incidentally, FIG. 2 is a schematic view, and thus a number of the particles, a distribution of the particles, or the like, are not restricted to one shown by FIG. 2.

As shown in FIG. 2, the first layer 64a contains a first Si-containing particle 12 as the negative electrode active material. The second layer 64b contains a second Si-containing particle 14 as the negative electrode active material.

In this embodiment, an expansion rate S2 of the second Si-containing particle 14 is smaller than the expansion rate S1 of the first Si-containing particle 12. When the expansion rate S1 of the first Si-containing particle 12 is treated as 1, the expansion rate S2 of the second Si-containing particle 14 is, for example, more than 0.3 and not more than 0.9, and it is, from a perspective of implementing an effect of a herein disclosed technique, preferably 0.4 to 0.8. The expansion rate S1 and the expansion rate S2 herein mean a volume expansion rate of the first Si-containing particle 12 or the second Si-containing particle 14 after the electrical charge A with respect to one before the electrical charge A. The expansion rate S1 and the expansion rate S2 can be suitably changed, for example, by changing the Si content rates of the first Si-containing particle 12 and the second Si-containing particle 14, a void amount of the carbon base material, or the like.

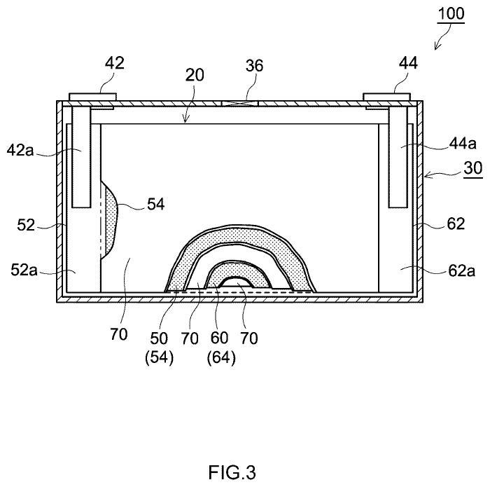

The electrical charge A herein is an electrical charge in which, after a constant current electrical charge is performed under 25° C. environment by a current value being 0.01 C till 4.2 V, a constant voltage electrical charge is performed till the current value reaches 0.005 C. The electrical charge A is performed, for example, on a secondary battery for evaluation (for example, the lithium ion secondary battery) that includes the negative electrode containing only the first Si-containing particle or the second Si-containing particle as the negative electrode active material. For the electrical charge A, it is preferable that the secondary battery for evaluation is, for example, in a condition where a SOC (a state of charge) is 0%. Although not particularly restricting, it is preferable that the electrical charge A is performed, for example, before an initial electrical charge of the secondary battery for evaluation is performed. Incidentally, the secondary battery for evaluation described above might include the same configuration as the lithium ion secondary battery 100 (see FIG. 3), other than the configuration in which the negative electrode active material layer contains only the first Si-containing particle or the second Si-containing particle as the negative electrode active material.

The expansion rate S1 can be obtained, for example, as described below. At first, a cross section being along a thickness direction of the negative electrode active material layer containing only the first Si-containing particle as the negative electrode active material is processed for observation with an electron microscope (SEM). The process described above is performed, under a condition with 4 kV voltage and 8 hours processing time, by using a cross section polisher (CP) equipment. Next, a SEM observation image of a processing surface is obtained. It is good that an observation magnification at that time is set to be, for example, 1000 times to 4000 times. Next, the secondary battery for evaluation including this negative electrode active material layer is constructed, and then the electrical charge A is performed on this. Next, the secondary battery for evaluation is disassembled and then the negative electrode is taken out. Next, a SEM observation on the processing surface, whose SEM observation image was obtained before the electrical charge A, is performed and thus the SEM observation image after the electrical charge A is obtained. Then, while an image analyzing software (for example, “ImageJ”) is used, area sizes P1 of 100 first Si-containing particles selected at random from the SEM observation image before the electrical charge A are measured, and additionally area sizes P2 of the same first Si-containing particles selected from the SEM observation image after the electrical charge A are measured. Then, for each of the particles, the expansion rate is calculated with below described Formula (A):

$$Expansion rate ( \% ) = {[ √ \{ ( Area size Q 2 ) / ( Area size Q 1 ) \} ]}^{3} \times 100 \qquad ( B )$$

An arithmetic average value for the herein obtained expansion rates of 100 particles is calculated, and it is treated as an expansion rate S1 of the first Si-containing particle.

The expansion rate S1 is, for example, equal to or more than 200%, or suitably equal to or less than 400%. Although not particularly restricting, the expansion rate S1 might be equal to or more than 210%, alternatively might be equal to or less than 380%, might be equal to or less than 360%, or might be equal to or less than 350%.

When the expansion rate S2 is obtained, at first, the cross section being along the thickness direction of the negative electrode active material layer containing only the second Si-containing particle as the negative electrode active material is processed for observation with the SEM. Regarding the expansion rate S2, for example, area sizes Q1 of 100 second Si-containing particles selected at random from the SEM observation image before the electrical charge A are measured, and area sizes Q2 of the same second Si-containing particles of the SEM observation image after the electrical charge A are measured. Then, for each of the particles, the expansion rate is calculated with below described Formula (B):

$$Expansion rate ( \% ) = {[ √ \{ ( Area size P 2 ) / ( Area size P 1 ) \} ]}^{3} \times 100 \qquad ( A )$$

An arithmetic average value for the herein obtained expansion rates of 100 particles is calculated, and then it is treated as the expansion rate S2 of the second Si-containing particle. Incidentally, here, a procedure for obtaining the expansion rate S2 might be the same as the procedure for obtaining the expansion rate S1. Thus, an explanation about the procedure for obtaining the expansion rate S2 is suitably omitted.

The expansion rate S2 is, for example, equal to or more than 100%, or suitably less than 200%. Although not particularly restricting, the expansion rate S2 might be equal to or more than 110%, might be equal to or more than 120%, might be alternatively equal to or less than 190%, or might be equal to or less than 180%.

A mean particle diameter (D50) of the first Si-containing particle 12 and a mean particle diameter (D50) of the second Si-containing particle 14 are not particularly restricted, and are, for example, 0.5 μm to 25 μm, preferably 1 μm to 20 μm, or further preferably 2 μm to 15 μm. The mean particle diameter (D50) of the first Si-containing particle 12 and the mean particle diameter (D50) of the second Si-containing particle 14 might be the same or might be different from each other.

Incidentally, in the present description, the term “mean particle diameter (D50)” represents a median diameter (D50), and represents a particle diameter corresponding to cumulative frequency 50 volume % from a side of a fine particle, whose particle diameter is smaller, with respect to a particle size distribution on a volume basis according to a laser diffraction and scattering method. The mean particle diameter (D50) can be obtained with a commercially available particle size distribution measuring apparatus configured in a laser diffraction and scattering style, or the like.

As shown in FIG. 2, the first Si-containing particle 12 contained in the first layer 64a includes a core particle 121 and a coating layer 122. The core particle 121 is, for example, a Si-containing particle. The coating layer 122 herein is arranged on at least a part of a surface of the core particle 121. As shown in FIG. 2, the second Si-containing particle 14 contained in the second layer 64b includes a core particle 141 and a coating layer 142. The core particle 141 is, for example, a Si-containing particle. The coating layer 142 herein is arranged on at least a part of a surface of the core particle 141. It is enough that the Si-containing particles configuring the core particle 121 and the core particle 141 contain the Si, and they might be, for example, Si particles, Si oxide particles, Si—C composite particles, or the like. It is good that both of the core particle 121 and the core particle 141 are the Si—C composite particles. The Si—C composite particle includes, for example, a carbon domain and a Si-containing domain.

The carbon domain is, for example, a carbon idea of a carbon precursor (for example, a petroleum pitch, a coal pitch, a phenolic resin, or the like); a graphite; or the like. The carbon domain suitably configures a carbon matrix. It is good that the Si—C composite particle is, for example, a particle in which the Si-containing domain is dispersed into the carbon matrix. The Si—C composite particle can include, for example, plural Si-containing domains in the carbon matrix. In this case, the carbon matrix can relieve a volume change caused by an expansion and a contraction of the Si-containing domain, and thus it is advantageous.

The Si-containing domain contains the Si, and is configured with, for example, the Si, a Si oxide (SiOₓ), a Si nitride (SiNₓ), a Si carbide (SiCₓ), or the like. The Si-containing domain is configured with preferably at least any of the Si and the Si oxide (SiOₓ). The Si-containing domain might be a nanoparticle. An oxygen content amount of the Si-containing domain is preferably equal to or less than 10 mass %.

A mean particle diameter of the Si-containing domain is, for example, equal to or less than 50 nm, or might be 5 nm to 50 nm. Incidentally, said “mean particle diameter of the Si-containing domain” can be obtained as described below. At first, the negative electrode active material layer 64 is subjected to a FIB (a focused ion beam) processing, so as to manufacture a specimen for a scan transmission electron microscope (STEM) observation. Then, after this specimen is subjected to an element analysis by EDX elemental mapping, a BF image (a bright field image) and a HAADF image (a high angle annular dark field image) are obtained. From a contrast and a shape obtained with the BF image and the HAADF image, it is possible to obtain a diameter of the Si-containing domain. Diameters of arbitrary selected 10 or more Si-containing domains are obtained, and a mean value of them herein is treated as said “mean particle diameter of the Si-containing domain”.

The Si—C composite particle includes, for example, a carbon base material and the Si contained at an inside of the carbon base material. The carbon base material is preferably, for example, including a void, or is furthermore preferably being a porous carbon base material. The Si contained at the inside of the carbon base material is, for example, to have a size capable of being contained at the inside of the carbon base material, or it is good to have a size capable of being contained in the void when the carbon base material includes the void. From a perspective described above, it is preferable that the Si contained at an inside of the carbon base material is a Si-containing nanoparticle (for example, a Si nanoparticle, a Si oxide nanoparticle, a Si nitride nanoparticle, a Si carbide nanoparticle, or the like) whose mean particle diameter (here, a mean particle diameter of the Si-containing domain) is approximately 1 nm to 300 nm (preferably, 1 nm to 200 nm, or further preferably 1 nm to 100 nm). From a perspective of suppressing a volume change of the Si and consequently relieving the volume changes of the first Si-containing particle 12 and the second Si-containing particle 14, it is preferable that the Si—C composite particle contains a particle including a carbon base material having a void (further preferably, a porous carbon base material) and the Si arranged inside the void (for example, the Si-containing nanoparticle). Alternatively, in another embodiment, the Si—C composite particle might contain the carbon particle and the Si-containing nanoparticle adhered to a surface of the carbon particle, or might contain the particle containing the Si and the carbon nanoparticle adhered to the surface of the particle containing the Si.

The coating layer 122 and the coating layer 142 herein contain LiFs. Existences of the coating layer 122 and the coating layer 142 can be, for example, confirmed by a measurement with an X-ray photoelectron spectroscopy (XPS) on the first Si-containing particle 12 and the second Si-containing particle 14. A content rate of the LiF in the coating layer 122 (a concentration of the LiF) is, on the XPS spectrum of the first Si-containing particle 12 measured with the XPS, to correspond to a ratio of a peak intensity of a F of the LiF with respect to a peak intensity of the F of one being other than the LiF. A content rate of the LiF in the coating layer 142 (the concentration of the LiF) is, on the XPS spectrum of the second Si-containing particle 14 measured with the XPS, to correspond to a ratio of a peak intensity of a F of the LiF with respect to a peak intensity of the F of one being other than the LiF. Incidentally, on the XPS spectrum measured with the XPS, the peak of the F of the LiF appears at 683 eV to 686 eV. The peak of the F of one being other than the LiF is the peak of the F outside the range of being 683 eV to 686 eV, and especially appears at 687 eV to 690 eV.

Here, on the XPS spectrum of the first Si-containing particle 12 measured with the XPS, the ratio of the peak intensity of the F of the LiF with respect to the peak intensity of the F of one being other than the LiF is treated as a first peak intensity ratio. On the XPS spectrum of the second Si-containing particle 14, the ratio of the peak intensity of the F of the LiF with respect to the peak intensity of the F of one being other than the LiF is treated as a second peak intensity ratio. Here, the first peak intensity ratio is larger than the second peak intensity ratio. In this embodiment, the wording “the first peak intensity ratio is larger than the second peak intensity ratio” means that a difference between the first peak intensity ratio and the second peak intensity ratio is at least 0.050. The difference between the first peak intensity ratio and the second peak intensity ratio is preferably equal to or more than 0.075, further preferably equal to or more than 0.100, or furthermore preferably equal to or more than 0.125. Although not particularly restricting, from a perspective of implementing a suitable electrically conductive property of the negative electrode 60, the difference between the first peak intensity ratio and the second peak intensity ratio is approximately equal to or less than 0.750, for example, equal to or less than 0.600, preferably equal to or less than 0.500, further preferably equal to or less than 0.450, or furthermore preferably equal to or less than 0.425.

It is good that the first peak intensity ratio is approximately 0.450 to 1.00. The first peak intensity ratio is, for example, equal to or more than 0.460, preferably equal to or more than 0.480, or further preferably equal to or more than 0.500. The first peak intensity ratio is, for example, equal to or less than 0.900, preferably equal to or less than 0.850, further preferably equal to or less than 0.800, or furthermore preferably equal to or less than 0.750. It is good that the second peak intensity ratio is approximately equal to or more than 0.200 and less than 0.450. The second peak intensity ratio is, for example, equal to or more than 0.250, preferably equal to or more than 0.250, or further preferably equal to or more than 0.300. The second peak intensity ratio is, for example, equal to or less than 0.420, preferably equal to or less than 0.400, or further preferably equal to or less than 0.380.

What the core particle 121 includes the coating layer 122 and what the core particle 141 includes the coating layer 142 can be confirmed, for example, by a SEM observation. A covering rate on the surface of the core particle 121 by the coating layer 122 is, for example, equal to or more than 20%, preferably equal to or more than 50%, further preferably equal to or more than 80%, or furthermore preferably equal to or more than 90%, and it is better as it is closer to 100%. A covering rate on the surface of the core particle 141 by the coating layer 142 is, for example, equal to or more than 20%, preferably equal to or more than 50%, further preferably equal to or more than 80%, or furthermore preferably equal to or more than 90%, and it is better as it is closer to 100%. Although not particularly restricting, a covering rate of the core particle 121 surface by the coating layer 122 regarding the first Si-containing particle 12 might be, for example, larger than the covering rate of the core particle 141 surface by the coating layer 142 regarding the second Si-containing particle 14. Incidentally, the covering rate by the coating layer 122 or by the coating layer 142 can be obtained as described below. A SEM observation image of a cross section of the first Si-containing particle 12 or the second Si-containing particle 14 is obtained. On this image, a rate (a percentage) of a total length of the coating layer 122 or the coating layer 142 with respect to a perimeter of the core particle 121 or the core particle 141 is calculated. For arbitrarily selected 5 or more first Si-containing particles 12 or second Si-containing particles 14, these rates are calculated and then a mean value of them is treated as the covering rate.

A content rate of the Si in the first Si-containing particle 12 and a content rate of the Si in the second Si-containing particle 14 might be the same or might be different from each other. Although not particularly restricting, it is good that the content rate of the Si in the first Si-containing particle 12 and the content rate of the Si in the second Si-containing particle 14 are approximately 20 mass % to 80 mass %.

Incidentally, the first Si-containing particle 12 and the second Si-containing particle 14 can be manufactured by a well known method. Incidentally, various manufacturing methods of the particle of the Si—C composite material are well known (for example, see Japanese Patent Application Publication No. 2015-38862, International Patent Publication No. 2014/046144, prior art documents recited in these publications, or the like).

As shown in FIG. 2, the first layer 64a further contains a first graphite particle 16 as the negative electrode active material. The second layer 64b further contains a second graphite particle 18 as the negative electrode active material. It is good that each of the first graphite particle 16 and the second graphite particle 18 is a graphite particle substantially not containing the Si. Both of the Si content rate of the first graphite particle 16 and the Si content rate of the second graphite particle 18 are approximately equal to or less than 10 mass %, for example, equal to or less than 7 mass %, preferably equal to or less than 5 mass %, further preferably equal to or less than 3 mass %, or furthermore preferably equal to or less than 1 mass %, alternatively equal to or less than 0.5 mass %, and thus it is better as closer to 0 mass %. The Si content rate can be calculated, for example, by a conventionally known method, such as ICP analysis.

Each of the graphites configuring the first graphite particle 16 and the second graphite particle 18 might be a natural graphite or an artificial graphite, or might be an amorphous carbon coated graphite having a form in which the graphite is coated with an amorphous carbon material.

The shapes of the first graphite particle 16 and the second graphite particle 18 are not particularly restricted, and might be scaly shapes, spheroidized shapes, or the like. The first graphite particle 16 and the second graphite particle 18 are preferably spheroidized graphite particles. In a situation where the first graphite particle 16 and the second graphite particle 18 are spheroidized, circularities of the first graphite particle 16 and the second graphite particle 18 are preferably 0.85 to 1, further preferably 0.88 to 1, or furthermore preferably 0.90 to 1.

Incidentally, the term “circularity” in the present description represents a ratio of a perimeter of a perfect circle whose area size is the same as a projected area size of a particle with respect to a perimeter of a particle projected image (in other words, the circularity=the perimeter of the perfect circle whose area size is the same as the projected area size/the perimeter of the particle projected image). Thus, as the circularity is closer to 1, it means that the particle projected image is closer to the perfect circle and the particle becomes closer to a perfect spherical shape. The circularity can be obtained, for example, by using a commercially available static automatic image analysis apparatus, obtaining the circularities of 100 or more particles, and calculating a mean value for them.

A first mean particle diameter (D50) of the graphite particle 16 and a mean particle diameter (D50) of the second graphite particle 18 are not particularly restricted. Each of the mean particle diameter (D50) of the first graphite particle 16 and the mean particle diameter (D50) of the second graphite particle 18 is, for example, 1 μm to 30 μm, preferably 5 μm to 25 μm, further preferably 10 μm to 23 μm, or furthermore preferably 12 μm to 20 μm.

As the first graphite particle 16 and the second graphite particle 18, the same graphite particles might be used or different graphite particles might be used. As the first graphite particle 16 and the second graphite particle 18, it is preferable to use the same graphite particles.

Regarding the first layer 64a, in a situation where the first graphite particle 16 is contained, when a sum of the first Si-containing particle 12 and the first graphite particle 16 is treated as 100 mass %, a rate of the first Si-containing particle 12 is, for example, 5 mass % to 60 mass %, preferably 10 mass % to 50 mass %, or further preferably 15 mass % to 40 mass %. Incidentally, the first graphite particle 16 is, for example, used for enhancing the electrically conductive property of the negative electrode active material layer 64, and thus a matter of containing it is not essential. In another embodiment, regarding the first layer 64a, the first graphite particle 16 might be not contained.

The negative electrode active material contained in the first layer 64a might be only the first Si-containing particle 12 and the first graphite particle 16, or might be only the first Si-containing particle 12. However, if an effect of a herein disclosed technique can be implemented, the first layer 64a might contain another negative electrode active material, which is different from any of the first Si-containing particle 12 and the first graphite particle 16. In this situation, a rate of said another negative electrode active materials is preferably equal to or less than 10 mass % of the total amount of the negative electrode active material contained in the first layer 64a.

Regarding the second layer 64b, in a situation where the second graphite particle 18 is contained, when a sum of the second Si-containing particle 14 and the second graphite particle 18 is treated as 100 mass %, a rate of the second Si-containing particle 14 is, for example, 10 mass % to 60 mass %, preferably 15 mass % to 50 mass %, or further preferably 20 mass % to 40 mass %. Incidentally, the second graphite particle 18 is, for example, used for enhancing the electrically conductive property of the negative electrode active material layer 64, and thus a matter of containing it is not essential. In another embodiment, regarding the second layer 64b, the second graphite particle 18 might be not contained.

The negative electrode active material contained in the second layer 64b might be only the second Si-containing particle 14 and the second graphite particle 18, or might be only the second Si-containing particle 14. However, if the effect of the herein disclosed technique can be implemented, the second layer 64b might contain another negative electrode active material, which is different from any of the second Si-containing particle 14 and the second graphite particle 18. In this situation, a rate of said another negative electrode active materials is preferably equal to or less than 10 mass % of the total amount of the negative electrode active material contained in the second layer 64b.

In the negative electrode active material layer 64, a ratio (T_{A}:T_{B}) of a thickness (T_{A}) of the first layer 64a and a thickness (TB) of the second layer 64b is approximately 5:95 to 95:5, for example, 10:90 to 90:10, preferably 20:80 to 80:20, further preferably 30:70 to 70:30, or furthermore preferably 40:60 to 60:40.

The negative electrode active material layer 64 might contain a component other than the negative electrode active material, and it is possible as an example of it to use a binder, an electrically conducting material, or the like. As the binder, for example, it is possible to use a styrene butadiene rubber (SBR), carboxymethyl cellulose (CMC), polyacrylic acid (PAA), polyvinylidene fluoride (PVDF), or the like. The CMC functions as a thickening agent, too. As an example of the electrically conducting material, it is possible to use a carbon black, such as acetylene black, a carbon fiber, a carbon nanotube (CNT), or the like, as the example of the electrically conducting material. Among them, the CNT is preferable. In a situation where the CNT is used as the electrically conducting material, the negative electrode active material layer 64 might contain a dispersing agent for the CNT.

A total mass of the negative electrode active material layer in the first layer 64a (in other words, with respect to a total mass of the first layer 64a) is preferably equal to or more than 90 mass %, or further preferably equal to or more than 95 mass %. A content amount of the binder in the negative electrode active material layer is preferably equal to or more than 0.1 mass % and not more than 8 mass %, or further preferably equal to or more than 0.5 mass % and not more than 5 mass %. A content amount of the electrically conducting material in the negative electrode active material layer 64 is preferably equal to or more than 0.01 mass % and not more than 3 mass %, or further preferably equal to or more than 0.05 mass % and not more than 1 mass %.

A content amount of the negative electrode active material in the second layer 64b (in other words, with respect to a total mass of the second layer 64b) is preferably equal to or more than 90 mass %, or further preferably equal to or more than 95 mass %. A content amount of the binder in the negative electrode active material layer is preferably equal to or more than 0.1 mass % and not more than 8 mass %, or further preferably equal to or more than 0.5 mass % and not more than 5 mass %. A content amount of the electrically conducting material in the negative electrode active material layer 64 is preferably equal to or more than 0.01 mass % and not more than 3 mass %, or further preferably equal to or more than 0.05 mass % and not more than 1 mass %.

A thickness of the negative electrode active material layer 64 is, which is not particularly restricted, for example, equal to or more than 10 μm and not more than 400 μm, or preferably equal to or more than 20 μm and not more than 300 μm.

Although a density of the negative electrode active material layer 64 is not particularly restricted, it is, for example, equal to or more than 0.7 g/cm³, preferably equal to or more than 1.0 g/cm³, or further preferably equal to or more than 1.2 g/cm³. On the other hand, the density of the negative electrode active material layer 64 might be, for example, equal to or less than 2.3 g/cm³, or might be equal to or less than 2.0 g/cm³.

The negative electrode 60 might include a member other than the negative electrode current collector 62 and the negative electrode active material layer 64. For example, on the negative electrode active material layer non-formation part 62a, an insulation layer (not shown in drawings) might be provided that is positioned adjacent to the negative electrode active material layer 64. This insulation layer includes, for example, an inorganic filler having an insulating property, or the like.

As described above, the negative electrode 60 for the secondary battery includes the negative electrode current collector 62 and the negative electrode active material layer 64. The negative electrode active material layer 64 is supported by the negative electrode current collector 62. The negative electrode active material layer 64 includes the first layer 64a positioned at the negative electrode current collector 62 side and the second layer 64b positioned at the surface layer side. The first layer 64a contains the first Si-containing particle 12 as the negative electrode active material. The second layer 64b contains the second Si-containing particle 14 as the negative electrode active material. When the expansion rate S1 of the first Si-containing particle 12 after the electrical charge A with respect to one before the electrical charge A is treated as 1, the expansion rate S2 of the second Si-containing particle 14 after the electrical charge A with respect to one before the electrical charge A is more than 0.3 and not more than 0.9. Here, the electrical charge A is an electrical charge in which, after a constant current electrical charge is performed under 25° C. environment by a current value being 0.01 C till 4.2 V, a constant voltage electrical charge is performed till the current value reaches 0.005 C.

Each of the first Si-containing particle 12 and the second Si-containing particle 14 includes the LiF coating layer (here, the LiF coating layer contained in the coating layer 122 or the coating layer 142). On the XPS spectrum of the first Si-containing particle 12 measured with the XPS, the ratio of the peak intensity of the F of the LiF with respect to the peak intensity of the F of one being other than the LiF is defined as the first peak intensity ratio. On the XPS spectrum of the second Si-containing particle 14, the ratio of the peak intensity of the F of the LiF with respect to the peak intensity of the F of one being other than the LiF is defined as a second peak intensity ratio. The first peak intensity ratio is larger than the second peak intensity ratio. A difference between the first peak intensity ratio and the second peak intensity ratio is at least 0.050.

The negative electrode 60 contains the first Si-containing particle 12 whose expansion rate is relatively larger and the second Si-containing particle 14 whose expansion rate is relatively smaller. In the negative electrode 60, the negative electrode active material layer 64 includes the first layer 64a at the negative electrode current collector 62 side and the second layer 64b at the surface layer side. When the electrical charge and the electrical discharge are repeated, regarding the negative electrode active material layer 64, the swell at the surface layer side becomes relatively larger. When the second Si-containing particle 14 whose expansion rate is relatively smaller is arranged on the second layer 64b at the surface layer side, it is possible on the second layer 64b to make the particle become to further easily move. Thus, by a movement of the particle at the expansion and contraction time due to the electrical charge and discharge, it is possible to relieve the stress, and to suppress the swell on the negative electrode. Then, regarding the negative electrode 60, the first Si-containing particle 12 whose expansion rate is relatively larger is contained in the first layer 64a. The expansion rate S2 of the second Si-containing particle 14 is set to be more than 0.3 and not more than 0.9, with respect to the expansion rate S1 of the first Si-containing particle 12. By this, it is possible to make a degree of the expansion and contraction of the whole negative electrode active material layer 64 at the electrical charge and discharge time be further uniform. Thus, it is possible to suppress the situation where the reaction, the stress, or the like is locally concentrated on the negative electrode active material layer 64, and therefore it is possible to suppress the swell of the negative electrode 60 when the electrical charge and the electrical discharge are repeated.

In addition to this, each of the first Si-containing particle 12 and the second Si-containing particle 14 includes the LiF coating layer on the surface. The LiF coating layer can follow the expansion and contraction of the Si-containing particle, and thus it is possible to suppress the particle surface from being exposed due to the expansion and contraction. Here, the first peak intensity ratio of the first Si-containing particle 12 is larger than the second peak intensity ratio of the second Si-containing particle 14. In other words, the first Si-containing particle 12 whose expansion rate is relatively larger has a formation amount of the LiF coating layer on the particle surface which is larger than the second Si-containing particle 14 whose expansion rate is relatively smaller. By this, the exposure of the particle surface due to the expansion and contraction described above can be suppressed, and thus it is possible to suppress a reaction, a stress, or the like from being concentrated locally on the negative electrode active material layer 64. Therefore, it is possible to suppress the swell of the negative electrode 60 when the electrical charge and the electrical discharge are repeated.

The first peak intensity ratio might be 0.450 to 1.00. By this, it is possible, when the electrical charge and the electrical discharge are repeated, to suitably suppress an exposed portion from being caused on the surfaces of the first Si-containing particle 12 and the second Si-containing particle 14. Further, by forming the LiF coating layer, it is possible to suppress a resistance of the negative electrode 60 from becoming too larger. Furthermore, by a side reaction on the LiF coating layer, it is possible to suppress the Si-containing particle from becoming easily expanded.

The second peak intensity ratio might be equal to or more than 0.200 and less than 0.450. By this, it is possible, when the electrical charge and the electrical discharge are repeated, to suitably suppress the exposed portion from being caused on the surfaces of the first Si-containing particle 12 and the second Si-containing particle 14.

The first Si-containing particle 12 might contain the Si—C composite particle (here, the core particle 121) including the carbon base material and the Si contained at the inside of the carbon base material, and contain the LiF coating layer (here, the LiF coating layer contained in the coating layer 122) arranged on at least a part of the surface of this Si—C composite particle (here, the core particle 121). The second Si-containing particle 14 might contain the Si—C composite particle (here, the core particle 141) including the carbon base material and the Si contained at the inside of the carbon base material, and contain the LiF coating layer (here, the LiF coating layer contained in the coating layer 142) arranged on at least a part of the surface of this Si—C composite particle (here, the core particle 141). By this, it is possible to relieve the expansion of the Si in the carbon base material, and thus it is possible to suppress the expansions of the first Si-containing particle 12 and the second Si-containing particle 14. Thus, it is possible, when the electrical charge and the electrical discharge are repeated, to suppress the swell of the negative electrode 60.

The first layer 64a, further, might contain a first graphite particle 16, as the negative electrode active material, which substantially does not contain the Si. The second layer 64b, further, might contain a second graphite particle 18, as the negative electrode active material, which substantially does not contain the Si. By this, on the first layer 64a and the second layer 64b, it is possible to enhance an electrically conductive property.

The negative electrode 60 is manufactured by a manufacturing method that includes, for example, a first preparing step, a second preparing step, a first coating application step, a first drying step, a second coating application step, a second drying step, and a pressing step.

The first preparing step is, for example, a step for preparing a first paste that contains the first Si-containing particle as the negative electrode active material and contains the dispersion medium. The first preparing step can be performed, according to a well known method, by mixing the first Si-containing particle 12, the first graphite particle 16 as needed, and an arbitrary component (for example, binder, electrically conducting material, or the like) with a well known mixing device, stirring device, or the like, and by mixing the resultant into the dispersion medium (for example, water). Incidentally, in the present description, the term “paste” represents a mixture in which a part or all of solid contents are dispersed into the dispersion medium, and semantically covers so-called “slurry”, “ink”, or the like.

The first preparing step contains, for example, preparing the first Si-containing particle 12. At the preparing of the first Si-containing particle 12, for example, firstly, a Si-containing particle as the core particle 121 is prepared. The Si-containing particle as the core particle 121 is, for example, a Si—C composite particle. It is possible to prepare the Si—C composite particle, for example, with a well known method as described above.

Next, in a state where the obtained core particle 121 is dispersed into the water-soluble organic solvent, a water-soluble lithium salt and a fluorinated agent are made to react with the core particle 121 so as to generate the LiF. The LiF generated here becomes a coating layer 122 on the surface of the core particle 121.

As the water-soluble organic solvent agent, it is possible to use, for example, alcohols, such as ethanol (ethyl alcohol), or the like. As the water-soluble lithium salt, it is possible, for example, to use lithium acetate (dihydrate), lithium carbonate, lithium nitrate, lithium chloride, lithium hydroxide, or the like, and it is preferable to use the lithium acetate (dihydrate). As the fluorinated agent, it is possible to use hydrofluoric acid, ammonium fluoride, ammonium hydrogen fluoride, or the like, and it is preferable to use the ammonium fluoride.

In order to perform this operation, for example, at first, a solution of the water-soluble lithium salt, a dispersion liquid in which the core particle 121 is dispersed into the water or the water-soluble organic solvent, and a solution of the fluorinated agent are prepared. The solution of the water-soluble lithium salt and the dispersion liquid are mixed so as to manufacture a mixed solution. Under stirring, a solution of the fluorinated agent is added to the mixed solution. By this, the water-soluble lithium salt and the fluorinated agent are reacted so as to generate the LiF. By this, a reaction solution containing the LiF is obtained. In this reaction solution, it is possible to make a surface of the core particle 121 and the LiF come into contact with each other.

A reaction condition of the water-soluble lithium salt and the fluorinated agent might be similar to a well known synthesis condition of the LiF in which the water-soluble lithium salt and the fluorinated agent are used. For example, this reaction can be performed under a room temperature (in other words, 25° C.±10° C.) or might be performed under a heating condition. A reaction time might be suitably decided in accordance with concentrations of the water-soluble lithium salt and the fluorinated agent in the reaction solution, desired content rates of the LiF in the coating layer 122, or the like. As the reaction time is longer, the content rate of the LiF in the coating layer 122 becomes higher.

By recovering the core particle 121 from the reaction solution under a state where the reaction solution, in which the LiF was generated, is adhered to the surface and then by drying the core particle 121 on which the reaction solution, in which the LiF was generated, is adhered, it is possible to make the LiF adhere to the surface of the core particle 121, and it is possible to obtain the first Si-containing particle 12 which includes the coating layer 122 containing the LiF. In order to adjust an amount of the LiF, the reaction solution in which the LiF was generated might be diluted with a water, or the like.

The second preparing step is, for example, a step for preparing a second paste that contains the second Si-containing particle 14 as the negative electrode active material and contains the dispersion medium. The second preparing step can be performed, according to a well known method, by mixing the second Si-containing particle 14, the second graphite particle 18 as needed, and an arbitrary component (for example, a binder, an electrically conducting material, or the like) with a well known mixing device, stirring device, or the like, and by mixing the resultant into the dispersion medium (for example, the water).

The second preparing step contains, for example, preparing the second Si-containing particle 14. Preparing the second Si-containing particle 14 can be performed by using the Si—C composite particle as the core particle 141, and further by using another material and procedure when the first Si-containing particle 12 is prepared so as to suitably change the condition.

The first coating application step is, for example, a step for applying the first paste to coat the negative electrode current collector 62. The first coating application step can be performed on the basis of a well known method. For example, by applying the obtained first paste to coat the negative electrode current collector 62 with a coating application, such as gravure coater, comma coater, slit coater, and die coater, it is possible to perform the first coating application step.

The first drying step is, for example, a step for drying the first paste applied to coat the negative electrode current collector 62 and thus forming a dry layer of the first paste. The first drying step can be performed on the basis of a well known method. For example, by removing the dispersion medium from the negative electrode current collector 62 on which the first paste is applied to coat with a drying equipment, such as drying furnace, the dry layer of the first paste is formed. By this, it is possible to perform the first drying step. A drying temperature and a drying time can be suitably decided in accordance with a solid content concentration of the first paste, and thus are not particularly restricted. The drying temperature is, for example, equal to or more than 60° C. and not more than 200° C., or preferably equal to or more than 70° C. and not more than 150° C. The drying time is, for example, equal to or more than 10 seconds and not more than 30 minutes, or preferably equal to or more than 30 seconds and not more than 10 minutes.

The second coating application step is, for example, a step for applying the second paste to coat the dry layer of the first paste. The second coating application step can be performed on the basis of a well known method. For example, by applying the obtained second paste with the above described device to coat the dry layer of the first paste, it is possible to perform the second coating application step.

The second drying step is, for example, a step for drying the second paste applied to coat the dry layer of the first paste and thus forming the dry layer of the second paste. The second drying step can be performed on the basis of a well known method. The device and several conditions for drying, which are used at the second drying step, are similar to the explanation described for the first drying step.

The pressing step is, for example, a step for pressing the dry layer of the first paste and the dry layer of the second paste. The pressing step can be performed on the basis of a well known method. For example, by applying a pressure with a roller press, or the like, on the dry layer of the first paste and the dry layer of the second paste, it is possible to perform the pressing step. By performing the pressing step, it is possible to tightly pack the first Si-containing particle 12, the second Si-containing particle 14, and the first graphite particle 16 and second graphite particle 18 as needed. As described above, it is possible to obtain the negative electrode 60 that includes the negative electrode active material layer 64 including the first layer 64a and the second layer 64b.

By the negative electrode 60 in accordance with the present embodiment, it is possible to suppress the swell of the negative electrode 60 when the electrical charge and the electrical discharge are repeated on the secondary battery. The negative electrode 60 in accordance with the present embodiment uses the negative electrode active material containing the Si, and thus it is possible to make the secondary battery have a higher capacity.

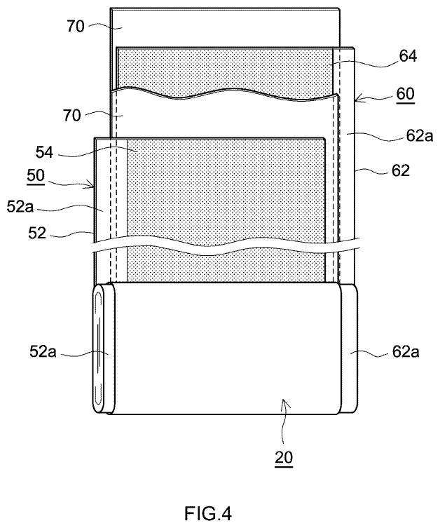

Then, from a different aspect, the herein disclosed secondary battery includes the positive electrode, the negative electrode, and an electrolyte. This negative electrode is the negative electrode 60 in accordance with the above described embodiment. Below, the lithium ion secondary battery is treated as an example, and then one embodiment of the herein disclosed secondary battery would be explained while referring to FIG. 3 and FIG. 4. A below described configuration example is a lithium ion secondary battery that is formed in a flat square shape and that includes a wound electrode assembly formed in a flat shape and includes a battery case formed in a flat shape.

The lithium ion secondary battery 100 shown in FIG. 3 is the sealed type lithium ion secondary battery 100 constructed by accommodating the flat-shaped wound electrode assembly 20 and the nonaqueous electrolytic solution (not shown in drawings) in the battery case (in other words, the outer container) 30 formed in a flat square shape. The battery case 30 is provided with a positive electrode terminal 42 and a negative electrode terminal 44 which are for outside connection, and provided with a thin-walled safe valve 36 which is set to release an internal pressure of the battery case 30 when the internal pressure is increased to be equal to or more than a predetermined level. The battery case 30 is provided with an injection port (not shown in drawings) for injecting the nonaqueous electrolytic solution. The positive electrode terminal 42 is electrically connected to a positive electrode current collection plate 42a. The negative electrode terminal 44 is electrically connected to the negative electrode current collection plate 44a. As a material of the battery case 30, for example, it is possible to use a metal material, such as aluminum, being lightweight and having a good thermal conductivity.

The wound electrode assembly 20 has a form, as shown by FIG. 3 and FIG. 4, in which a positive electrode sheet 50 and a negative electrode sheet 60 are stacked one on another via 2 long separator sheets 70 and then wound in a longitudinal direction. The positive electrode sheet 50 has a configuration in which a positive electrode active material layer 54 is formed on one surface or both surfaces (here, both surfaces) of a long positive electrode current collector 52 along the longitudinal direction. The negative electrode sheet 60 has a configuration in which the negative electrode active material layer 64 is formed on one surface or both surfaces (here, both surfaces) of the long negative electrode current collector 62 along the longitudinal direction. A positive electrode active material layer non-formation part 52a (in other words, a portion where the positive electrode active material layer 54 is not formed and the positive electrode current collector 52 is exposed) and the negative electrode active material layer non-formation part 62a (in other words, a portion where the negative electrode active material layer 64 is not formed and the negative electrode current collector 62 is exposed) are formed to protrude outwardly from both ends of the wound electrode assembly 20 in the winding axis direction (in other words, a sheet width direction orthogonal to the longitudinal direction). To the positive electrode active material layer non-formation part 52a and the negative electrode active material layer non-formation part 62a, the positive electrode current collection plate 42a and the negative electrode current collection plate 44a are respectively joined.

As the positive electrode current collector 52 configuring the positive electrode sheet 50, it is possible to use a well known positive electrode current collector that is used for the lithium ion secondary battery, and it is possible as an example of it to use a sheet or a foil which is made from a metal having the good electrically conductive property (for example, aluminum, nickel, titanium, stainless steel, or the like). As the positive electrode current collector 52, it is preferable to use the aluminum foil.

A size of the positive electrode current collector 52 is not particularly restricted, and can be decided suitably according to a battery design. In a situation where the aluminum foil is used as the positive electrode current collector 52, a thickness of it is not particularly restricted, but is, for example, equal to or more than 5 μm and not more than 35 μm, or preferably equal to or more than 7 μm and not more than 20 μm.

The positive electrode active material layer 54 contains a positive electrode active material. As the positive electrode active material, it is possible to use a positive electrode active material which is used for the lithium ion secondary battery and whose composition is well known. In particular, for example, it is possible as the positive electrode active material to use a lithium composite oxide, a lithium transition metal phosphate compound, or the like. The crystal structure of the positive electrode active material is not particularly restricted, but might be a layered structure, a spinel structure, an olivine structure, or the like.

Regarding the lithium composite oxide, it is preferable as a transition metal element to use a lithium transition metal complex oxide containing at least 1 kind among Ni, Co, and Mn, and it is possible as a specific example of it to use a lithium nickel base composite oxide, a lithium cobalt base composite oxide, a lithium manganese base composite oxide, a lithium nickel manganese base composite oxide, a lithium nickel cobalt manganese base composite oxide, a lithium nickel cobalt aluminum base composite oxide, a lithium iron nickel manganese base composite oxide, or the like.

Incidentally, the term “lithium nickel cobalt manganese base composite oxide” in the present description is a term semantically covering not only the oxide whose constituent element is Li, Ni, Co, Mn, or O, but also an oxide containing 1 kind, 2 kinds, or more kinds of additive elements other than them. As an example of the additive element described above, it is possible to use a transition metal element, such as Mg, Ca, Al, Ti, V, Cr, Y, Zr, Nb, Mo, Hf, Ta, W, Na, Fe, Zn, and Sn, a typical metal element, or the like. The additive element might be a semimetal element, such as B, C, Si, and P, or a non-metal element, such as S, F, Cl, Br, and I. This matter is similar even on the above described lithium nickel base composite oxide, lithium cobalt base composite oxide, lithium manganese base composite oxide, lithium nickel manganese base composite oxide, lithium nickel cobalt aluminum base composite oxide, lithium iron nickel manganese base composite oxide, or the like.

As the lithium transition metal phosphate compound, it is possible to use, for example, lithium iron phosphate (LiFePO₄), lithium manganese phosphate (LiMnPO₄), lithium manganese iron phosphate, or the like.

Regarding these positive electrode active materials, 1 kind might be used alone, or 2 or more kinds might be combined so as to be used. As the positive electrode active material, the lithium nickel cobalt manganese base composite oxide is especially preferable because it has superior characteristics, such as initial resistance characteristic.

The mean particle diameter (D50) of the positive electrode active material is not particularly restricted, but is, for example, equal to or more than 0.05 μm and not more than 25 μm, preferably equal to or more than 1 μm and not more than 20 μm, or further preferably equal to or more than 3 μm and not more than 15 μm.

The positive electrode active material layer 54 might contain a component other than the positive electrode active material, such as trilithium phosphate, electrically conducting material, and binder. As the electrically conducting material, it is possible to suitably use, for example, a carbon black, such as acetylene black (AB); a carbon fiber, such as vapor grown carbon fiber (VGCF) and carbon nanotube (CNT); or another carbon material (for example, a graphite, or the like). As the binder, it is possible to use, for example, polyvinylidene fluoride (PVdF), or the like.

A content amount of the positive electrode active material in the positive electrode active material layer 54 (in other words, a content amount of the positive electrode active material with respect to a total mass of the positive electrode active material layer 54) is not particularly restricted, but preferably equal to or more than 70 mass %, further preferably equal to or more than 80 mass %, or furthermore preferably equal to or more than 85 mass % and not more than 99 mass %. The content amount of the trilithium phosphate in the positive electrode active material layer 54 is not particularly restricted, but is preferably equal to or more than 0.1 mass % and not more than 15 mass %, or further preferably equal to or more than 0.2 mass % and not more than 10 mass %. The content amount of the electrically conducting material in the positive electrode active material layer 54 is not particularly restricted, but preferably equal to or more than 0.1 mass % and not more than 20 mass %, or further preferably equal to or more than 0.3 mass % and not more than 15 mass %. A content amount of the binder in the positive electrode active material layer 54 is not particularly restricted, but preferably equal to or more than 0.4 mass % and not more than 15 mass %, or further preferably equal to or more than 0.5 mass % and not more than 10 mass %.

A thickness per one surface of the positive electrode active material layer 54 is not particularly restricted, but is normally equal to or more than 10 μm, or preferably equal to or more than 20 μm. On the other hand, this thickness is normally equal to or less than 400 μm, or preferably equal to or less than 300 μm.

As the negative electrode sheet 60, the above described negative electrode 60 is used.

As the separator 70, it is possible to use, for example, a porous sheet (film) configured with a resin, such as polyethylene (PE), polypropylene (PP), polyester, cellulose, and polyamide. The porous sheet described above might have a single layer structure, or might have two or more layers laminate structure (for example, a three layers structure in which PP layers are laminated on both surfaces of a PE layer). On a surface of the separator 70, a heat resistance layer (HRL) might be provided.

A thickness of the separator 70 is not particularly restricted, but is, for example, equal to or more than 5 μm and not more than 50 μm, or preferably equal to or more than 10 μm and not more than 30 μm. An air permeability of the separator 70 obtained by Gurley test is not particularly restricted, but is preferably equal to or less than 350 second/100 cc.

The nonaqueous electrolytic solution contains, typically, a nonaqueous solvent and a supporting salt (an electrolyte salt). As the nonaqueous solvent, it is possible without particular restriction to use an organic solvent, such as carbonates, ethers, esters, nitriles, sulfones, and lactones, which can be used for the electrolytic solution of a general lithium ion secondary battery. Among them, the carbonates are preferable, and it is possible as a specific example of them to use ethylene carbonate (EC), propylene carbonate (PC), diethyl carbonate (DEC), dimethyl carbonate (DMC), ethyl methyl carbonate (EMC), monofluoroethylene carbonate (FEC), difluoroethylene carbonate (DFEC), monofluoromethyl difluoromethyl carbonate (F-DMC), trifluoro dimethyl carbonate (TFDMC), or the like. Regarding the nonaqueous solvents as described above, it is possible to use 1 kind alone or to combine 2 or more kinds so as to use the resultant. As one example, the nonaqueous solvent consists of only the carbonates. As another example, the nonaqueous solvent contains the carbonates and the esters, such as methyl acetate.

As the supporting salt, it is possible to suitably use, for example, a lithium salt, such as LiPF₆, LiBF₄, and lithium bis(fluorosulfonyl)imide (LiFSI) (preferably, the LiPF₆). A concentration of the supporting salt is preferably equal to or more than 0.7 mol/L and not more than 1.3 mol/L.

Incidentally, the above described nonaqueous electrolytic solution might contain a component other than the above described components, insofar as the effect of the present disclosure is not significantly spoiled, and thus might contains, for example, various additive agents which might be a coating layer forming agent, such as vinylene carbonate (VC) and oxalate complex; a gas generating agent, such as biphenyl (BP) and cyclohexylbenzene (CHB); a thickening agent; or the like.

The lithium ion secondary battery 100 can be used for various purposes. As a suitable usage, it is possible to apply it for a driving power supply mounted on a vehicle, such as battery electric vehicle (BEV), hybrid electric vehicle (HEV), and plug-in hybrid electric vehicle (PHEV). The lithium ion secondary battery 100 can be used as a storage battery, such as small electric power storage device. The lithium ion secondary battery 100 can be used, typically, in a form of a battery pack in which plural ones are connected in series and/or in parallel.

Above, as one example, the square-shaped lithium ion secondary battery 100 including the flat-shaped wound electrode assembly 20 has been explained. However, the lithium ion secondary battery can be configured to be a lithium ion secondary battery including a laminate type electrode assembly (in other words, an electrode assembly in which plural positive electrodes and plural negative electrodes are alternately laminated), too. The lithium ion secondary battery can be configured to be a cylindrical-shaped lithium ion secondary battery, a laminate case type lithium ion secondary battery, or the like.

According to a well known method, the lithium ion secondary battery 100 can be configured to be an all-solid state lithium ion secondary battery in which a solid electrolyte is used instead of the nonaqueous electrolyte.

The negative electrode 60 in accordance with the present embodiment is suitable for the negative electrode of the lithium ion secondary battery, but can be constructed for the negative electrode of the other secondary battery so as to be used, and the other secondary battery can be configured according to a well known method.

Below, a practical example relating to the present disclosure would be described in detail, which is not intended to restrict the present disclosure into this practical example.

<Manufacture of Si—C Composite Particle with Coating Layer Containing LiF>

The Si—C composite particles (A) to (J) as the core particle were prepared. Each of the Si—C composite particle (A) to (J) prepared here was a particle that included a porous carbon base material and a Si nanoparticle arranged at an inside of a void of this carbon base material. The Si—C composite particle (A) was a particle whose expansion rate was 258%. Si—C composite particle (B) was a particle whose expansion rate was 153%. Si—C composite particle (C) was a particle whose expansion rate was 228%. Si—C composite particle (D) was a particle whose expansion rate was 173%. Si—C composite particle (E) was a particle whose expansion rate was 339%. Si—C composite particle (F) was a particle whose expansion rate was 126%. Si—C composite particle (G) was a particle whose expansion rate was 416%. Si—C composite particle (H) was a particle whose expansion rate was 121%. Si—C composite particle (I) was a particle whose expansion rate was 217%. Si—C composite particle (J) was a particle whose expansion rate was 176%.

### <Measurement of Expansion Rate>

Incidentally, the expansion rate of the core particle was obtained by a procedure described below. The negative electrode having the same configuration as the below described Practical example 1, other than using only any of the core particles described above as the negative electrode active material, was manufactured with a material and procedure the same as said example. A cross section along the thickness direction of this negative electrode was processed to be for the SEM observation, and then the SEM observation image of its processing surface was obtained. The observation magnification at that time was 1,500 times. Next, a battery for measurement being the lithium ion secondary battery having the same configuration as said example, other than using this negative electrode, was manufactured with the procedure the same as said example. The battery for measurement was kept under 25° C. environment, was subjected to the constant current electrical charge by the current value being 0.01 C till 4.2 V, and then was subjected to the constant voltage electrical charge till the current value reached 0.005 C, as the electrical charge. After that, the battery for measurement was disassembled, and the negative electrode was taken out. After that, the SEM observation was performed on the processing surface from which the SEM observation image was obtained before the electrical charge, and then the SEM observation image after the electrical charge was obtained. Then, the image analyzing software “ImageJ” was used, 100 first particles were selected at random from the SEM observation image before the electrical charge, and the area sizes A1 of the selected particles were measured. Next, regarding the SEM observation image after the electrical charge, the area sizes A2 of the same first particles were measured. Next, for each of the particles, the expansion rate was calculated with following Formula (R):

$$Expansion rate ( \% ) = {[ √ \{ ( Area size A 2 ) / ( Area size A 1 ) \} ]}^{3} \times 100 \qquad ( R )$$

An arithmetic average value for the herein obtained expansion rates of 100 particles was calculated, and then treated as the expansion rate of the Si-containing particle.

### Practical Example 1

As the negative electrode active material, the first particle and the second particle were prepared. For preparing the first particle, the Si—C composite particle (A) was prepared as a core particle. While the core particle was subjected to an ultrasonic processing for 30 minutes, it was dispersed into the ethyl alcohol. The lithium acetate was dissolved into deionized water, so that the lithium acetate solution was prepared. Into this solution, the dispersion liquid of the Si—C composite particle was added while being stirred for 30 minutes. Into it, an ammonium fluoride solution was added while being stirred for 60 minutes, so that the lithium acetate and the ammonium fluoride were made to react. By this, the reaction solution containing the LiF was obtained. The reaction solution was diluted, and then it was filtrated. A filtration residue was dried, so that a coating layer containing the LiF was provided on the Si—C composite particle (A). The procedure for preparing the second particle was the same as the procedure for preparing the first particle, other than using the Si—C composite particle (B) as the core particle and making the adding time of the ammonium fluoride solution (in other words, a reaction time) be 120 minutes.

As the XPS spectrum with respect to the obtained first particle and second particle was measured, a peak of the F of the Li—F (about 684.8 eV) and a peak of the Li of the Li—F (about 55.1 eV) were observed, and thus it was confirmed that the LiF was contained. For the first particle, the ratio of the peak intensity of the F of the LiF with respect to the peak intensity of the F of one being other than the LiF (below, which might be referred to as “first LiF intensity ratio”, too) was obtained. For the second particle, the ratio of the peak intensity of the F of the LiF with respect to the peak intensity of the F of one being other than the LiF (below, which might be referred to as “second LIF intensity ratio”, too) was obtained. The result is shown in an applicable column of Table 1. Incidentally, the peak of the F of the LiF appeared at 683 eV to 686 eV, and a peak of the F of one being other than the LiF appeared at 687 eV to 690 eV. Further, as the negative electrode active material, the graphite particle whose mean particle diameter (D50) was 15 μm was prepared. The graphite particle described above was the graphite particle that substantially did not contain the Si. The dispersion liquid of the single-walled carbon nanotube (SWCNT) being as the electrically conducting material was prepared. As the binder, the carboxymethyl cellulose (CMC), the polyacrylic acid (PAA), and the styrene butadiene rubber (SBR) were prepared.

The above described materials were kneaded with a water as a solvent to make a mass ratio satisfy graphite particle/first particle/SWCNT/CMC/PAA/SBR=80/20/7/0.1/1/1/1.5, so as to manufacture the first paste with a below described procedure. The above described materials were kneaded with the water as the solvent to make a mass ratio satisfy graphite particle/second particle/SWCNT/CMC/PAA/SBR=70/30/0.1/1/1/1.5, so as to manufacture the second paste with the below described procedure.

The graphite particle, the first particle, the CMC, and the PAA were dry-blended with a planetary mixer. The obtained dry mixture, the SWCNT dispersion liquid, and the dispersion medium were kneaded with the planetary mixer. Further, by putting the SBR and additional dispersion medium into the planetary mixer to dilute and mix, the first paste was obtained.

The graphite particle, the second particle, the CMC, and the PAA were dry-blended with the planetary mixer. The obtained dry mixture, the SWCNT dispersion liquid, and the dispersion medium were kneaded with the planetary mixer. Further, by putting the SBR and the additional dispersion medium into the planetary mixer so as to dilute and mix, the second paste was obtained.

The first paste was applied to coat the surface of the copper foil whose thickness was 10 μm, and then the resultant was dried, so that the dry layer of the first paste was formed. Next, the second paste was applied to coat the dry layer of the first paste, and then the resultant was dried, so that the dry layer of the second paste was formed. Here, an application amount of the second paste was set to make a thickness of the dry layer of the second paste satisfy be 50 when a thickness of the negative electrode active material layer (here, a sum thickness of the dry layer of the first paste and the dry layer of the second paste) was treated as 100. Then, after the negative electrode active material layer was roll-pressed, the obtained sheet was processed to have a predetermined dimension, so that the negative electrode sheet was obtained.

### Practical Example 2

For preparing the first particle, the Si—C composite particle (C) was used as the core particle, and the adding time of the ammonium fluoride solution was set to be 90 minutes. For preparing the second particle, the Si—C composite particle (D) was used as the core particle. Other than those, a material and procedure similar to Practical example 1 were used, so that the negative electrode sheet of the present example was obtained.

### Practical Example 3

For preparing the first particle, the Si—C composite particle (E) was used as the core particle and the adding time of the ammonium fluoride solution was set to be 150 minutes. For preparing the second particle, the Si—C composite particle (F) was used as the core particle. Other than those, a material and procedure similar to Practical example 1 were used, so that the negative electrode sheet of the present example was obtained.

### Comparative Example 1

To make the mass ratio satisfy graphite particle/first particle/second particle/SWCNT/CMC/PAA/SBR=70/10/15/0.1/1/1/1.5, it was kneaded with the water as the solvent, so that the negative electrode paste was manufactured. The negative electrode paste was manufactured by performing a first step and a second step which are described below. At the first step, firstly, the first particle, the second particle, a paste-formed SWCNT (a solid content rate was 2%), and the dispersion medium were put into a kneading device, and subjected to a dispersion mixing at 3000 rpm with a disper, so that the first paste was manufactured. At the second step, a stirring granulator was used and thus the graphite particle, the CMC, and the PAA were subjected to a dry mixing. The first paste, a powder mix obtained by the dry mixing, and the dispersion medium (the water) were subjected to a thick kneading. The solid content rate at the thick kneading time was 65%. Into the mixture on which the thick kneading was performed, the SBR and the dispersion medium (the water) were further added and then mixed. As described above, the negative electrode paste was manufactured. The manufactured negative electrode paste was applied to coat the surface of the copper foil whose thickness was 10 μm, and was dried, so that the negative electrode active material layer was formed. After the negative electrode active material layer was roll-pressed, the obtained sheet was processed to have a predetermined size. Other than this, a material and procedure similar to Practical example 1 were used, so that the negative electrode sheet of the present example was obtained.

### Comparative Example 2

As the first particle, the Si—C composite particle (A) was used. As the second particle, the Si—C composite particle (B) was used. On the Si—C composite particle (A) and the Si—C composite particle (B), the LiF coating layer was not formed. Other than this, the material and procedure similar to Practical example 1 were used, so that the negative electrode sheet of the present example was obtained.

### Comparative Example 3

For preparing the first particle, the Si—C composite particle (F) was used as the core particle, and the adding time of the ammonium fluoride solution was set to be 60 minutes. For preparing the second particle, the Si—C composite particle (A) was used as the core particle, and the adding time of the ammonium fluoride solution was set to be 120 minutes. Other than this, the material and procedure similar to Practical example 1 were used, so that the negative electrode sheet of the present example was obtained.

### Comparative Example 4

As the second particle, the Si—C composite particle (B) was used. On the Si—C composite particle (B), the LiF coating layer was not formed. Other than this, the material and procedure similar to Practical example 1 were used, so that the negative electrode sheet of the present example was obtained.

### Comparative Example 5

As the first particle, the Si—C composite particle (A) was used. On the Si—C composite particle (A), the LiF coating layer was not formed. Other than this, the material and procedure similar to Practical example 1 were used, so that the negative electrode sheet of the present example was obtained.

### Comparative Example 6

For preparing the first particle, the Si—C composite particle (G) was used as the core particle, and the adding time of the ammonium fluoride solution was set to be 240 minutes. For preparing the second particle, the Si—C composite particle (H) was used as the core particle. Other than those, the material and procedure similar to Practical example 1 were used, so that the negative electrode sheet of the present example was obtained.

### Comparative Example 7

For preparing the first particle, the Si—C composite particle (I) was used as the core particle, and the adding time of the ammonium fluoride solution was set to be 60 minutes. For preparing the second particle, the Si—C composite particle (J) was used as the core particle. Other than those, the material and procedure similar to Practical example 1 were used, so that the negative electrode sheet of the present example was obtained.

### <Electrode Plate Expansion Rate Evaluation>

The thickness of the negative electrode of each practical example and each comparative example was measured. This thickness was treated as an initial thickness (TO). With this negative electrode, a lithium ion secondary battery for evaluation was manufactured as described below.

LiNi_{1/3}C_{1/3}Mn_{1/3}O₂ (NCM) as the positive electrode active material powder, acetylene black (AB) as the electrically conducting material, and polyvinylidene fluoride (PVdF) as the binder were mixed at a mass ratio being NCM:AB:PVdF=100:1:1 with N-methylpyrrolidone (NMP), so that the positive electrode paste was prepared. This paste was applied to coat a surface of the aluminum foil whose thickness was 15 μm and was dried, so that the positive electrode active material layer was formed. After the positive electrode active material layer was subjected to the rolling press, the obtained sheet was processed to have a predetermined size, so that the positive electrode sheet was obtained.

A separator made from a porous polyolefin was prepared. To each of the above manufactured negative electrode sheet and positive electrode sheet, a lead was attached, and then the resultants were laminated via the separator, so that the electrode assembly was manufactured. This was accommodated together with the nonaqueous electrolytic solution in a case configured with an aluminum laminate film. As the nonaqueous electrolytic solution, a solution was used in which the LiPF₆ was dissolved as the supporting salt at a concentration being 1.0 mol/L into a mixed solvent containing the ethylene carbonate (EC), the fluoro ethylene carbonate (FEC), the ethyl methyl carbonate (EMC), and the dimethyl carbonate (DMC) at a volume ratio being 15:5:40:40. After that, the case was sealed, so that the lithium ion secondary battery for evaluation was obtained.

Next, each lithium ion secondary battery for evaluation manufactured above was kept under an environment being at 25° C. Each lithium ion secondary battery for evaluation was subjected to the constant current electrical charge by the current value being 0.4 C till 4.2 V, and then subjected to the constant voltage electrical charge till the current value reached 0.1 C. Next, each lithium ion secondary battery for evaluation was subjected to the constant current electrical discharge by the current value being 0.4 C till 2.5 V.

The electrical charge and discharge, in which the above described electrical charge and discharge was treated as 1 cycle, was repeated to satisfy 250 cycles. Each lithium ion secondary battery for evaluation was disassembled under an argon atmosphere, the negative electrode was immersed into the DMC to be washed, and then the resultant was dried. Then, the thickness of the negative electrode was measured, and then this thickness was treated as a thickness after the electrical charge and discharge cycle (T1). An increasing rate (%) of the negative electrode thicknesses before and after the electrical charge and discharge cycle was calculated by (T1/T0−1)×100. The results are shown at “Increasing rate (%)” column of Table 1. Incidentally, here, an example whose increasing rate was less than 33% is evaluated that the swell of the negative electrode in response to the electrical charge and discharge cycle was suppressed.

### [Table 1]

TABLE 1

| | First particle | | Second particle | | Ratio of | Negative | Increasing |
|---|---|---|---|---|---|---|---|
| | LiF coating | First LiF | LiF coating | Second LiF | expansion | electrode | rate |
| | layer | intensity ratio | layer | intensity ratio | rate* | configuration | (%) |
| Practical | Presence | 0.629 | Presence | 0.362 | 0.6 | Second layer | 26 |
| example 1 | | | | | | | |
| Practical | Presence | 0.524 | Presence | 0.373 | 0.8 | Second layer | 28 |
| example 2 | | | | | | | |
| Practical | Presence | 0.729 | Presence | 0.308 | 0.4 | Second layer | 31 |
| example 3 | | | | | | | |
| Comparative | Presence | 0.629 | Presence | 0.362 | 0.6 | First layer | 37 |
| example 1 | | | | | | | |
| Comparative | Absence | — | Absence | — | 0.6 | Second layer | 35 |
| example 2 | | | | | | | |
| Comparative | Presence | 0.362 | Presence | 0.629 | 1.7 | Second layer | 41 |
| example 3 | | | | | | | |
| Comparative | Presence | 0.629 | Absence | — | 0.6 | Second layer | 33 |
| example 4 | | | | | | | |
| Comparative | Absence | — | Presence | 0.362 | 0.6 | Second layer | 35 |
| example 5 | | | | | | | |
| Comparative | Presence | 1.281 | Presence | 0.301 | 0.3 | Second layer | 42 |
| example 6 | | | | | | | |
| Comparative | Presence | 0.358 | Presence | 0.361 | 0.8 | Second layer | 34 |
| example 7 | | | | | | | |

Ratio of expansion rate* = Expansion rate of second particle/Expansion rate of first particle

As shown by Table 1, in Practical examples 1 to 3, an increase in the increasing rate of the negative electrode thicknesses before and after the electrical charge and discharge cycle (the swell of the negative electrode) was suppressed. In Practical examples 1 to 3, as described above, the first particle was contained in a layer at the negative electrode current collector side of the negative electrode active material layer and the second particle was contained in a layer at the surface layer side. When the expansion rate of the first particle after the electrical charge A with respect to one before the electrical charge A was treated as 1, the expansion rate of the second particle after the electrical charge A with respect to one before the electrical charge A was more than 0.3 and not more than 0.9. The first particle and the second particle included the LiF coating layer. The ratio of the peak intensity of the F of the LiF with respect to the peak intensity of the F of one being other than the LiF on the XPS spectrum of the first particle was larger than the ratio of the peak intensity of the F of the LiF with respect to the peak intensity of the F of one being other than the LiF on the XPS spectrum of the second particle, and a difference between them was at least 0.050.

Above, specific examples of the present disclosure have been explained in detail, but these are merely illustrative, and are not construed as limiting the scope of the appended claims. The technique recited in claims contains matters in which the above-illustrated specific example is variously deformed or changed.

In short, the negative electrode of the secondary battery of the present disclosure, a manufacturing method of it, and the secondary battery are represented by Items [1] to [8].

[1] A negative electrode of a secondary battery, comprising:
a negative electrode current collector; and
a negative electrode active material layer that is supported by the negative electrode current collector, wherein
the negative electrode active material layer comprises a first layer positioned at a side of the negative electrode current collector and a second layer positioned at a surface layer side,
the first layer comprises a first Si-containing particle as a negative electrode active material,
the second layer comprises a second Si-containing particle as the negative electrode active material,
an expansion rate S2 of the second Si-containing particle after an electrical charge A with respect to before the electrical charge A, in which a constant current electrical charge is performed under 25° C. environment by a current value being 0.01 C till 4.2 V and then a constant voltage electrical charge is performed till the current value reaches 0.005 C, is more than 0.3 and not more than 0.9 when an expansion rate S1 of the first Si-containing particle after the electrical charge A with respect to before the electrical charge A is treated as 1,
each of the first Si-containing particle and the second Si-containing particle comprises a LiF coating layer, and
when, on an XPS spectrum of the first Si-containing particle measured by a X-ray photoelectron spectroscopy, a ratio of a peak intensity of an F of a LiF with respect to the peak intensity of the F of one being other than the LiF is defined as a first peak intensity ratio, and on an XPS spectrum of the second Si-containing particle, the ratio of the peak intensity of the F of the LiF with respect to the peak intensity of the F of one being other than the LiF is defined as a second peak intensity ratio, the first peak intensity ratio is larger than the second peak intensity ratio and a difference between the first peak intensity ratio and the second peak intensity ratio is at least 0.050.

[2] The negative electrode recited in [1], wherein
the first peak intensity ratio is equal to or more than 0.450 and not more than 1.00.

[3] The negative electrode recited in [1] or [2], wherein
the second peak intensity ratio is equal to or more than 0.200 and less than 0.450.

[4] The negative electrode recited in any one of [1] to [3], wherein
the first Si-containing particle and the second Si-containing particle comprise a Si—C composite particle comprising a carbon base material and comprising a Si contained at an inside of the carbon base material and comprise the LiF coating layer arranged at least on a part of a surface of the Si—C composite particle.

[5] The negative electrode recited in any one of [1] to [4], wherein
the first layer and the second layer further comprise a graphite particle, as the negative electrode active material, that substantially does not comprise a Si.

[6] A manufacturing method of a negative electrode of a secondary battery, comprising:
preparing a first paste that comprises a first Si-containing particle as a negative electrode active material and comprises a dispersion medium;
preparing a second paste that comprises a second Si-containing particle as the negative electrode active material and comprises the dispersion medium;
applying the first paste to coat a negative electrode current collector and to dry so as to form a dry layer of the first paste;
applying the second paste to coat the dry layer of the first paste and to dry so as to form a dry layer of the second paste; and
pressing the dry layer of the first paste and the dry layer of the second paste, wherein
an expansion rate S2 of the second Si-containing particle after an electrical charge A with respect to before the electrical charge A, in which a constant current electrical charge is performed under 25° C. environment by a current value being 0.01 C till 4.2 V and then a constant voltage electrical charge is performed till the current value reaches 0.005 C, is more than 0.3 and not more than 0.9 when an expansion rate S1 of the first Si-containing particle after the electrical charge A with respect to before the electrical charge A is treated as 1,
each of the first Si-containing particle and the second Si-containing particle comprises a LiF coating layer, and
when, on an XPS spectrum of the first Si-containing particle measured by a X-ray photoelectron spectroscopy, a ratio of a peak intensity of an F of a LiF with respect to the peak intensity of the F of one being other than the LiF is defined as a first peak intensity ratio, and on an XPS spectrum of the second Si-containing particle, the ratio of the peak intensity of the F of the LiF with respect to the peak intensity of the F of one being other than the LiF is defined as a second peak intensity ratio,
the first peak intensity ratio is larger than the second peak intensity ratio and a difference between the first peak intensity ratio and the second peak intensity ratio is at least 0.050.

[7] The manufacturing method recited in [6], wherein
the preparing the first paste comprises preparing the first Si-containing particle,
the preparing the second paste comprises preparing the second Si-containing particle,
at the preparing the first Si-containing particle and the preparing the second Si-containing particle,
a Si—C composite particle, comprising a carbon base material and comprising a Si comprised at an inside of the carbon base material, is prepared, and
by making the Si—C composite particle react with a water-soluble lithium salt and a fluorinated agent in a state where the Si—C composite particle is dispersed into a water or a water-soluble organic solvent so as to generate a LiF, the first Si-containing particle and the second Si-containing particle are prepared.

[8] A secondary battery, comprising:
a positive electrode;
a negative electrode; and
an electrolyte, wherein
the negative electrode is the negative electrode recited in any one of [1] to [5].

What is claimed is:

1. A negative electrode of a secondary battery, comprising:
a negative electrode current collector; and
a negative electrode active material layer that is supported by the negative electrode current collector, wherein
the negative electrode active material layer comprises a first layer positioned at a side of the negative electrode current collector and a second layer positioned at a surface layer side,
the first layer comprises a first Si-containing particle as a negative electrode active material,
the second layer comprises a second Si-containing particle as the negative electrode active material,
an expansion rate S2 of the second Si-containing particle after an electrical charge A with respect to before the electrical charge A, in which a constant current electrical charge is performed under 25° C. environment by a current value being 0.01 C till 4.2 V and then a constant voltage electrical charge is performed till the current value reaches 0.005 C, is more than 0.3 and not more than 0.9 when an expansion rate S1 of the first Si-containing particle after the electrical charge A with respect to before the electrical charge A is treated as 1,
each of the first Si-containing particle and the second Si-containing particle comprises a LiF coating layer, and
when, on an XPS spectrum of the first Si-containing particle measured by a X-ray photoelectron spectroscopy, a ratio of a peak intensity of an F of a LiF with respect to the peak intensity of the F of one being other than the LiF is defined as a first peak intensity ratio, and on an XPS spectrum of the second Si-containing particle, the ratio of the peak intensity of the F of the LiF with respect to the peak intensity of the F of one being other than the LiF is defined as a second peak intensity ratio,
the first peak intensity ratio is larger than the second peak intensity ratio, and a difference between the first peak intensity ratio and the second peak intensity ratio is at least 0.050.

2. The negative electrode according to claim 1, wherein
the first peak intensity ratio is equal to or more than 0.450 and not more than 1.00.

3. The negative electrode according to claim 1, wherein
the second peak intensity ratio is equal to or more than 0.200 and less than 0.450.

4. The negative electrode according to claim 1, wherein
the first Si-containing particle and the second Si-containing particle comprise a Si—C composite particle comprising a carbon base material and comprising a Si contained at an inside of the carbon base material and comprise the LiF coating layer arranged at least on a part of a surface of the Si—C composite particle.

5. The negative electrode according to claim 1, wherein
the first layer and the second layer further comprise a graphite particle, as the negative electrode active material, that substantially does not comprise a Si.

6. A manufacturing method of a negative electrode of a secondary battery, comprising:
preparing a first paste that comprises a first Si-containing particle as a negative electrode active material and comprises a dispersion medium;
preparing a second paste that comprises a second Si-containing particle as the negative electrode active material and comprises the dispersion medium;
applying the first paste to coat a negative electrode current collector and to dry so as to form a dry layer of the first paste;
applying the second paste to coat the dry layer of the first paste and to dry so as to form a dry layer of the second paste; and
pressing the dry layer of the first paste and the dry layer of the second paste, wherein
an expansion rate S2 of the second Si-containing particle after an electrical charge A with respect to before the electrical charge A, in which a constant current electrical charge is performed under 25° C. environment by a current value being 0.01 C till 4.2 V and then a constant voltage electrical charge is performed till the current value reaches 0.005 C, is more than 0.3 and not more than 0.9 when an expansion rate S1 of the first Si-containing particle after the electrical charge A with respect to before the electrical charge A is treated as 1,
each of the first Si-containing particle and the second Si-containing particle comprises a LiF coating layer, and
when, on an XPS spectrum of the first Si-containing particle measured by a X-ray photoelectron spectroscopy, a ratio of a peak intensity of an F of a LiF with respect to the peak intensity of the F of one being other than the LiF is defined as a first peak intensity ratio, and on an XPS spectrum of the second Si-containing particle, the ratio of the peak intensity of the F of the LiF with respect to the peak intensity of the F of one being other than the LiF is defined as a second peak intensity ratio,
the first peak intensity ratio is larger than the second peak intensity ratio, and a difference between the first peak intensity ratio and the second peak intensity ratio is at least 0.050.

7. The manufacturing method according to claim 6, wherein
the preparing the first paste comprises preparing the first Si-containing particle,
the preparing the second paste comprises preparing the second Si-containing particle,
at the preparing the first Si-containing particle and the preparing the second Si-containing particle,
a Si—C composite particle, comprising a carbon base material and comprising a Si comprised at an inside of the carbon base material, is prepared, and
by making the Si—C composite particle react with a water-soluble lithium salt and a fluorinated agent in a state where the Si—C composite particle is dispersed into a water or a water-soluble organic solvent so as to generate a LiF, the first Si-containing particle and the second Si-containing particle are prepared.

8. A secondary battery, comprising:
a positive electrode;
a negative electrode; and
an electrolyte, wherein
the negative electrode is the negative electrode according to claim 1.
